(19) United States
(12) Patent Application Publication
(10) Pub. No.: US 2019/0391678 A1
(43) Pub. Date: Dec. 26, 2019

(54) TOUCH DEVICE CAPABLE OF ILLUMINATING AND DISPLAYING BUTTONS

(71) Applicant: Dong Guan Song Wei Electric Technology Co., Ltd., Dongguan (CN)

(72) Inventor: Weilin Lu, Dongguan (CN)

(21) Appl. No.: 16/016,663

(22) Filed: Jun. 25, 2018

(51) Int. Cl. G06F 3/041

(52) U.S. Cl. CPC G06F 3/041; G06F 2203/04107

(57) ABSTRACT

A touch device capable of illuminating and displaying buttons includes a fixing frame, a touch panel, a sensing electrode, a light emitting member, a condensing lid, an imaging film, a translucent light shielding film, and a touch media. The condensing lid is located above the touch panel. The imaging film is located above the condensing lid. The imaging film is formed with image holes to display various button patterns. The translucent light shielding film is located above the imaging film. The touch media is located above the translucent light shielding film.

### BACKGROUND OF THE INVENTION

### 1. Field of the Invention

The present invention relates to a touch device, and more particularly, to a touch device capable of illuminating and displaying buttons.

### 2. Description of the Prior Art

With the rapid development of science and technology, many products use buttons to control their functions, such as electric fireplaces and heaters.

Electric fireplaces and heaters are common household appliances in the cold winter. They generally have heating and decorating functions and are ideal appliances for home life. While enjoying the convenience of electric fireplaces and heaters, people put forward more modern requirements. For the existing electric fireplaces and heaters, the light is generally emitted from a light emitting device, and the light is reflected to project on an imaging screen to form a flame.

However, the existing electric fireplaces or heaters use mechanical buttons or a silkscreen layer disposed on the inner surface of a touch media for displaying button information (some are provided with a mark text layer on a light guide layer). It is not easy to design the mechanical buttons, and the mechanical buttons cannot be hidden. As a result, the appearance of the product is unsightly. Although the silkscreen layer disposed on the inner surface of the touch media for displaying button information can be hidden, it is not clear when the buttons are displayed. The cost of the silkscreen layer (or the mark text layer) is high, and the processing is complicated.

### SUMMARY OF THE INVENTION

In view of the shortcomings of the prior art, the primary object of the present invention is to provide a touch device capable of illuminating and displaying buttons to effectively solve the problems of the prior art. In the prior art, it is not easy to design the mechanical buttons, and the buttons cannot be hidden. As a result, the appearance of the product is not beautiful. When a silkscreen layer is used to display the buttons, the buttons cannot be displayed clearly. The cost is high, and the processing is complicated.

In order to achieve the aforesaid object, the present invention adopts the following technical solutions:

A touch device capable of displaying buttons comprises a fixing frame, a touch panel, a sensing electrode, a light emitting member, a condensing lid, an imaging film, a translucent light shielding film, and a touch media. The touch panel, the sensing electrode, the light emitting member, the condensing lid, the imaging film, the translucent light shielding film and the touch media are all disposed in the fixing frame. The sensing electrode and the light emitting member are disposed on the touch panel and electrically connected to the touch panel. The condensing lid is located above the touch panel. The imaging film is located above the condensing lid. The imaging film is an opaque film. The imaging film has a plurality of image light-transmitting regions. The translucent light shielding film is located above the imaging film. The touch media is located above the translucent light shielding film and exposed outside the fixing frame.

Preferably, the light emitting member is an LED. The LED is a red, yellow, green or blue LED. The LED is packaged in a plug-in or surface-mount manner.

Preferably, the sensing electrode is a spring or a PCB metal pad.

Preferably, the light emitting member is disposed in the sensing electrode or directly soldered on the touch panel.

Preferably, the touch media is translucent black.

Preferably, baffle plates are provided between the touch panel and the condensing lid for the condensing lid to condense light. The sensing electrode and the light emitting member are located between every adjacent two of the baffle plates.

Compared with the prior art, the present invention has obvious advantages and beneficial effects. Specifically, it can be known from the above technical solutions:

Through the arrangement of the condensing lid, the imaging film and the translucent light shielding film, the condensing lid condenses the light emitted from the light emitting member and then irradiates the light to the imaging film. The imaging film is an opaque film. The imaging film has the plurality of image light-transmitting regions. The light passes through the light-transmitting regions and passes through the translucent light-shielding film to display the light-transmitting regions on the touch medium. When the light emitting member is switched off, the displayed button patterns disappear from the touch medium. The naked eye cannot see the buttons clearly to achieve the purpose of hidden buttons. The color is consistent with the surrounding as a whole. The product is more beautiful and practical for use. The processing is simple to reduce the cost.

Embodiments of the present invention will now be described, by way of example only, with reference to the accompanying drawings.

### BRIEF DESCRIPTION OF THE DRAWINGS

FIG. 1 is an exploded view in accordance with a preferred embodiment of the present invention;

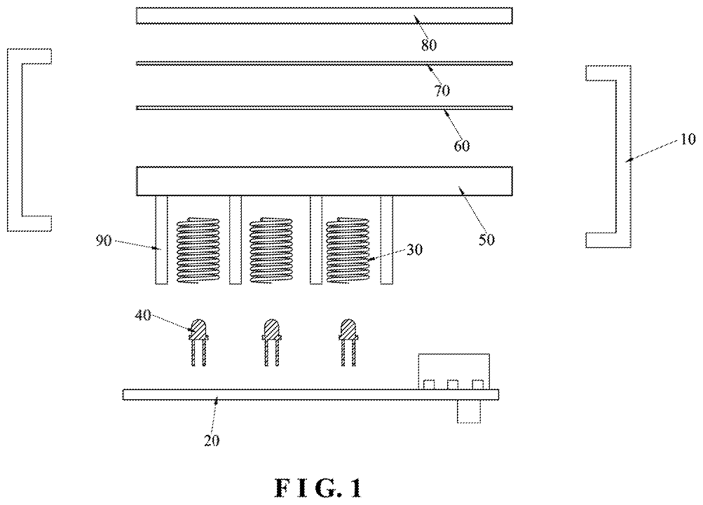

FIG. 2 is a sectional view in accordance with the preferred embodiment of the present invention; and

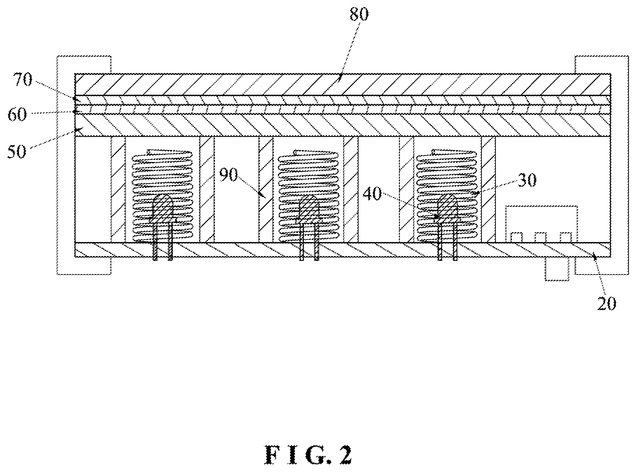

FIG. 3 is a front view of the imaging film in accordance with the preferred embodiment of the present invention.

### DETAILED DESCRIPTION OF THE PREFERRED EMBODIMENTS

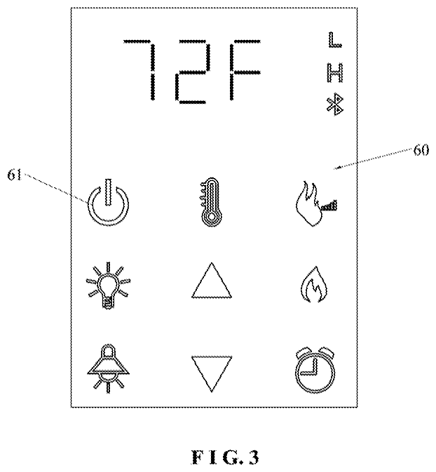

Referring to FIGS. 11 to 3, a specific structure of a preferred embodiment of the present invention is shown. The present invention comprises a fixing frame 10, a touch panel 20, a sensing electrode 30, a light emitting member 40, a condensing lid 50, an imaging film 60, a translucent light shielding film 70, and a touch media 80.

The touch panel 20, the sensing electrode 30, the light emitting member 40, the condensing lid 50, the imaging film 60, the translucent light shielding film 70 and the touch media 80 are all disposed in the fixing frame 10.

The sensing electrode 30 and the light emitting member 40 are both disposed on the touch panel 20 and electrically connected to the touch panel 20. In this embodiment, the sensing electrode 30 is a spring or a PCB metal pad. The light emitting member 40 is disposed in the sensing electrode 30 or directly soldered on the touch panel 20. The light emitting member 40 is an LED. The LED is a red, yellow, green or blue LED. The LED is packaged in a plug-in or surface-mount manner.

The condensing lid 50 is located above the touch panel 20. The condensing lid 50 condenses the light emitted from the light emitting member 40. The imaging film 60 is located above the condensing lid 50. The imaging film 60 is an opaque film. The imaging film 60 has a plurality of image light-transmitting regions 61. The light passes through the image light-transmitting regions 61 so that the patterns of the buttons corresponding to the image light-transmitting regions 61 are displayed. The translucent light shielding film 70 is located above the imaging film 60. When the light emitting member 40 is lighted up, the translucent light shielding film 70 transmits light. When the light emitting member 40 is switched off, the translucent light shielding film 70 does not transmit light. The touch media 80 is located above the translucent light shielding film 70 and exposed outside the fixing frame 10. The touch media 80 is translucent black. The surface layer of the touch media 80 is not printed with any text or nark. The touch media 80 is black when not in use, and is consistent with the color of the surrounding as a whole.

Baffle plates 90 are provided between the touch panel 20 and the condensing lid 50 for the condensing lid 50 to condense light. The sensing electrode 30 and the light emitting member 40 are located between every adjacent two of the baffle plates 90.

When in use, the touch media 80 is touched, and the sensing electrode 30 induces the light emitting member 40 to emit light. When the light emitting member 40 is lighted up, the condensing lid 50 condenses the light emitted from the light emitting member 40, and then irradiates the light to the imaging film 60. The light passes through the plurality of image light-transmitting regions 61 of the imaging film 60, so that the button patterns can be seen clearly from the front of the touch media 80. This is more beautiful and practical in use for the products. When the light emitting member 40 is switched off, the button patterns displayed on the image light-transmitting regions 61 gradually disappear from the touch medium 80, so the buttons cannot be clearly seen by the naked eyes to achieve the purpose of hidden buttons. The color is consistent with the surrounding as a whole.

The features of the present invention are as follows.

Through the arrangement of the condensing lid, the imaging film and the translucent light shielding film, the condensing lid condenses the light emitted from the light emitting member and then irradiates the light to the imaging film. The imaging film is an opaque film. The imaging film has the plurality of image light-transmitting regions. The light passes through the light-transmitting regions and passes through the translucent light-shielding film to display the light-transmitting regions on the touch medium. When the light emitting member is switched off the displayed button patterns disappear from the touch medium. The naked eye cannot see the buttons clearly to achieve the purpose of hidden buttons. The color is consistent with the surrounding as a whole. The product is more beautiful and practical for use.

Although particular embodiments of the present invention have been described in detail for purposes of illustration, various modifications and enhancements may be made without departing from the spirit and scope of the present invention. Accordingly, the present invention is not to be limited except as by the appended claims.

1: A touch device, comprising a fixing frame, a touch panel, a sensing electrode, a light emitting member, a condensing lid, an imaging film, a translucent light shielding film and a touch media; the touch panel, the sensing electrode, the light emitting member, the condensing lid, the imaging film, the translucent light shielding film and the touch media being all disposed in the fixing frame; the sensing electrode and the light emitting member being disposed on the touch panel and electrically connected to the touch panel; the condensing lid being located above the touch panel; the imaging film being located above the condensing lid; the imaging film being an opaque film, the imaging film having a plurality of image light-transmitting regions; the translucent light shielding film being located above the imaging film; the touch media being located above the translucent light shielding film and exposed outside the fixing frame;
wherein the translucent light shielding film that is located above the imaging film is located at an external side of the imaging film that faces away from the light emitting member and the condensing lid and the translucent light shielding film is located between the imaging film and the touch media.

2: The touch device as claimed in claim 1, wherein the light emitting member is an LED, the LED is a red, yellow, green or blue LED, and the LED is packaged in a plug-in or surface-mount manner.

3: The touch device as claimed in claim 1, wherein the sensing electrode is a spring or a PCB metal pad.

4: The touch device as claimed in claim 1, wherein the light emitting member is disposed in the sensing electrode or directly soldered on the touch panel.

5: The touch device as claimed in claim 1, wherein the touch media is translucent black.

6: The touch device as claimed in claim 1, wherein baffle plates are provided between the touch panel and the condensing lid for the condensing lid to condense light, the sensing electrode and the light emitting member are located between every adjacent two of the baffle plates.
